(19) United States
(12) Patent Application Publication
(10) Pub. No.: US 2024/0339622 A1
(43) Pub. Date: Oct. 10, 2024

(54) MODIFIED NEGATIVE ELECTRODE SHEET, AND PREPARATION METHOD AND APPLICATION THEREOF

(71) Applicant: EVE POWER CO., LTD., Jingmen (CN)

(72) Inventor: Changhai ZHU, Jingmen (CN)

(73) Assignee: EVE POWER CO., LTD., Jingmen (CN)

(21) Appl. No.: 18/475,271

(22) Filed: Sep. 27, 2023

(30) Foreign Application Priority Data
Apr. 10, 2023 (CN) 202310372803.9

(51) Int. Cl. H01M 4/62; H01M 4/04; H01M 10/0525

(52) U.S. Cl. CPC H01M 4/625; H01M 4/0471; H01M 4/622; H01M 10/0525; H01M 2004/027

(57) ABSTRACT

The present disclosure provides a modified negative electrode sheet, and a preparation method and application thereof. The modified negative electrode sheet includes a current collector, and a first negative electrode active material layer and a second negative electrode active material layer that are sequentially stacked on a surface of the current collector. Negative electrode active materials of the first active material layer are needle coke primary particles, and negative electrode active materials of the second active material layer are petroleum coke secondary particles.

The present disclosure claims priority to Chinese Patent Application No. 202310372803.9, filed on Apr. 10, 2023, and entitled “modified negative electrode sheet, and preparation method and application thereof”, the disclosure of which is incorporated herein by reference in its entirety.

### FIELD OF INVENTION

Embodiments of the present disclosure relate to the technical field of lithium-ion batteries, and in particular, to a modified negative electrode sheet, and a preparation method and application thereof.

### BACKGROUND OF INVENTION

With the promotion of new energy vehicles, lithium-ion batteries have become one of the research hotspots for researchers. However, the popularity of new energy vehicles greatly depends on their endurance mileage and fast charging performance, so lithium-ion batteries need to have the characteristics of fast charging, high specific energy, and the like.

Negative electrode materials are carriers of lithium ions and electrons during the charging and discharging processes of batteries, which play the role of energy storage and release. In the cost of batteries, negative electrode materials account for about 5% to 15%, which are one of the important raw materials for lithium-ion batteries. At present, the most widely used and mature commercial negative electrode materials are graphite negative electrode materials. Energy storage lithium-ion batteries require a long-term stable cycle performance for negative electrode materials, so as to ensure the continuous and stable normal operation of an energy storage system during long-term cyclic use.

CN112086645A discloses a negative electrode sheet of a lithium battery, which includes a substrate and a negative electrode coating layer coated on the substrate. The negative electrode coating layer is formed by condensation of negative electrode slurry. The negative electrode slurry includes an active material, a binder, and a conductive agent. The conductive agent is composed of carbon nanotubes and carbon nanohorns.

CN106848190A discloses a negative electrode sheet, which includes a bottom coating layer, a middle coating layer, and an upper coating layer that are sequentially coated on a surface of a current collector. The bottom coating layer, the middle coating layer, and the upper coating layer are formed by coating of slurry including a negative electrode active material, a conductive agent, a thickener, and a binder. The binders in the bottom coating layer and the middle coating layer are water-based slurry binders, and the content of the binders in the middle coating is less than that of the binders in the bottom coating layer. The binder in the upper coating layer is a solvent-based slurry binder.

In related arts, usually, negative electrode slurry is usually evenly coated on a current collector. This coating method will result in that lithium ions cannot be effectively transferred from an upper layer of an electrode sheet to a lower layer during the high-rate fast charging process, and the lithium ions will accumulate on the upper layer of the electrode sheet, ultimately resulting in lithium precipitation. It has seriously affected the service life and safety performance of battery cores.

### SUMMARY OF INVENTION

Embodiments of the present disclosure provide a modified negative electrode sheet, and a preparation method and application thereof. The modified negative electrode sheet in the present disclosure can effectively improve the fast charging performance of a battery core and prevent the negative electrode sheet from lithium precipitation during high-rate charging, thereby prolonging the service life of the battery core and improving the safety performance of the battery core. In addition, the negative electrode sheet can meet the requirement of high energy density of the battery core.

According to a first aspect, some embodiments of the present disclosure provide a modified negative electrode sheet. The modified negative electrode sheet includes a current collector, and a first negative electrode active material layer and a second negative electrode active material layer that are sequentially stacked on a surface of the current collector. Negative electrode active materials of the first negative electrode active material layer are needle coke primary particles, and negative electrode active materials of the second negative electrode active material layer are petroleum coke secondary particles.

In the modified negative electrode sheet of the present disclosure, the negative electrode active materials of the second active material layer are petroleum coke secondary particles, and an OI value of the secondary particles is small, which is beneficial for the diffusion of lithium ions into an inner layer, thereby preventing the phenomenon of lithium precipitation in high-rate charging and discharging processes, and improving the fast charging performance and safety performance of the battery core. The negative electrode active materials of the first active material layer are needle coke primary particles, and the primary particles can increase the compacted density of a negative electrode in the inner layer, thereby increasing the energy density of the battery core. Furthermore, the coating manner of coating the inner layer with the primary particles makes an internal structure of an electrode sheet more stable, which can improve the cycle performance of the battery core.

In some embodiments, the petroleum coke secondary particles are prepared by the following method:
mixing petroleum coke particles, resins and dispersants, and stirring and heating to obtain the petroleum coke secondary particles.

In some embodiments, the resin includes phenolic resin.

In some embodiments, the dispersant includes anhydrous ethanol.

In some embodiments, a mass ratio of the petroleum coke particles to the resins is 100:(5 to 10), such as 100:5, 100:6, 100:7, 100:8, 100:9, or 100:10.

In some embodiments, during the stirring and heating processes, the heating is performed as follows: heating the temperature from room temperature to 300° C. in a time period from 0.5 hours to 2 hours, then heating the temperature from 300° C. to 500° C. in a time period from 0.5 hours to 1.5 hours, and finally heating the temperature from 500° C. to a temperature ranging from 600° C. to 700° C. in a time period from 1 hour to 3 hours, and maintaining the temperature for 3 hours to 5 hours.

In some embodiments, an OI value of the needle coke primary particles ranges from 8 to 12, such as 8, 9, 10, 11, or 12.

In some embodiments, an OI value of the petroleum coke secondary particles ranges from 4 to 7, such as 4, 5, 6, or 7.

In some embodiments, a median particle diameter D50 of the needle coke primary particles ranges from 8 μm to 20 μm, such as 8 μm, 10 μm, 12 μm, 15 μm, or 20 μm.

In some embodiments, a median particle diameter D50 of the petroleum coke secondary particles ranges from 3 μm to 8 μm, such as 3 μm, 4 μm, 5 μm, 6 μm, 7 μm, or 8 μm.

In the modified negative electrode sheet of the present disclosure, the particle diameter of active material particles of negative electrode slurry coated on an outer layer is small, which is beneficial for the diffusion of lithium ions into an inner layer, thereby preventing lithium precipitation of the lithium ions in high-rate charging and discharging processes, and improving the fast charging performance and safety performance of the battery core.

In some embodiments, a thickness of the first negative electrode active material layer ranges from 110 μm to 120 μm, such as 110 μm, 112 μm, 115 μm, 118 μm, or 120 μm.

In some embodiments, a thickness of the second negative electrode active material layer ranges from 75 μm to 80 μm, such as 75 μm, 76 μm, 77 μm, 78 μm, 79 μm, or 80 μm.

In some embodiments, the first negative electrode active material layer and the second negative electrode active material layer further include conductive agents and binders.

In some embodiments, the conductive agent includes any one of or a combination of at least two of conductive carbon black, a carbon nanotube, and acetylene black.

In some embodiments, the binder includes polyvinylidene fluoride.

In some embodiments, a mass ratio of the needle coke primary particles, the conductive agents, and the binders in the first negative electrode active material layer is (96 to 97):(0.5 to 1):(2 to 3), such as 96.5:0.9:2.6, 96.2:0.8:3, 96.5:0.8:2.7, or 97:0.5:2.5.

In some embodiments, a mass ratio of the petroleum coke secondary particles, the conductive agents, and the binders in the second negative electrode active material layer is (95 to 97):(1 to 1.5):(2.5 to 3), such as 96:1.2:2.8, 95.5:1.5:3, 96.5:1:2.5, or 96.5:1:2.5.

According to a second aspect, some embodiments of the present disclosure provide a method for preparing the modified negative electrode sheet according to the first aspect. The preparation method includes the following steps:
(1) mixing the needle coke primary particles, the conductive agents, carboxymethyl cellulose (CMC), the binders, and a solvent to obtain a first negative electrode slurry; and mixing the petroleum coke secondary particles, the conductive agents, the CMC, the binders, and the solvent to obtain a second negative electrode slurry; and
(2) coating the first negative electrode slurry on one side or two sides of the current collector with the first negative electrode slurry, oven-drying the first negative electrode slurry, drying, and then coating the second negative electrode slurry on a surface of the first negative electrode slurry, followed by drying and cold pressing to obtain the modified negative electrode sheet.

According to a third aspect, some embodiments of the present disclosure provide a lithium-ion battery. The lithium-ion battery includes the modified negative electrode sheet according to the first aspect.

Compared to the related arts, the embodiments of the present disclosure have the following beneficial effects:
(1) In the modified negative electrode sheet according to the embodiments of the present disclosure, the active materials of a negative electrode slurry coated on an outer layer are petroleum coke secondary particles, and the OI value of the secondary particles is small, which is beneficial for the diffusion of lithium ions into an inner layer, thereby preventing lithium precipitation of the lithium ions in high-rate charging and discharging processes, and improving the fast charging performance and safety performance of the battery core. The active materials of a negative electrode slurry coated on an inner layer are needle coke primary particles, and the primary particles can increase the compacted density of a negative electrode in the inner layer, thereby increasing the energy density of the battery core. Furthermore, the coating manner of coating the inner layer with the primary particles makes an internal structure of an electrode sheet more stable, which can improve the cycle performance of the battery core.
(2) The 4C fast-charge cycling of the battery core prepared from the negative electrode sheet according to the embodiments of the present disclosure can reach 2350 times or more, the capacity retention rate can reach 85.6% or more, and the 0.33C energy density can reach 280 Wh/Kg or more.

### DETAILED DESCRIPTION OF PREFERRED EMBODIMENTS

The petroleum coke secondary particles used in the examples and comparative examples of the present disclosure were prepared by the following method:

A binder pitch with a mass fraction of 8% was added to raw petroleum coke powders, which were fully mixed and stirred evenly in a VC mixer for 1 h with a frequency of 50 Hz to obtain a mixture. The mixture was placed in a self-made converter for granulating under the protection of 0.1 L/min N₂, the frequency of the converter was 20 Hz, the temperature was raised to 650° C. at a heating rate of 3° C./min, and the temperature was kept for 2 h. Then, the granulated mixture was placed in a graphitization furnace, and subjected to high-temperature graphitization at a high temperature of 2800° C. to obtain petroleum coke secondary particles.

### Example 1

This example provides a modified negative electrode sheet. A method for preparing the modified negative electrode sheet was as follows:
(1) Needle coke primary particles with a median particle diameter D50 of 15 μm and an OI value of 10, conductive carbon black, carboxymethyl cellulose (CMC), and styrene butadiene rubber (SBR) were mixed with a solvent in a mass ratio of 96.5:0.9:1.1:1.5 to obtain a first negative electrode slurry. Petroleum coke secondary particles with a median particle diameter D50 of 5 μm and an OI value of 5, conductive carbon black, CMC, and SBR were mixed with a solvent in a mass ratio of 96:1.2:1.3:1.5 to obtain a second negative electrode slurry.
(2) The first negative electrode slurry was coated on one side or two sides of a current collector, and dried. Then the second negative electrode slurry was coated on a surface of the first negative electrode slurry, followed by drying and cold pressing to obtain the modified negative electrode sheet. In the negative electrode sheet, a thickness of the first active material layer was 116 μm, and a thickness of the second active material layer was 77 μm.

### Example 2

This example provides a modified negative electrode sheet. A method for preparing the modified negative electrode sheet was as follows:
(1) Needle coke primary particles with a median particle diameter D50 of 15 μm and an OI value of 10, conductive carbon black, CMC, and SBR were mixed with a solvent in a mass ratio of 96.5:0.9:1.1:1.5 to obtain a first negative electrode slurry. Petroleum coke secondary particles with a median particle diameter D50 of 5 μm and an OI value of 5, conductive carbon black, CMC, and SBR were mixed with a solvent in a mass ratio of 96:1.2:1.3:1.5 to obtain a second negative electrode slurry.
(2) The first negative electrode slurry was coated on one side or two sides of a current collector, and dried. Then the second negative electrode slurry was coated on a surface of the first negative electrode slurry, followed by drying and cold pressing to obtain the modified negative electrode sheet. In the negative electrode sheet, a thickness of the first active material layer was 135 μm, and a thickness of the second active material layer was 58 μm.

### Example 3

The difference between this example and Example 1 was only that in this example, a median particle diameter D50 of the needle coke primary particles was 5 μm. Other conditions and parameters were exactly the same as those in Example 1.

### Example 4

The difference between this example and Example 1 was only that in this example, a median particle diameter D50 of the needle coke primary particles was 25 μm. Other conditions and parameters were exactly the same as those in Example 1.

### Example 5

The difference between this example and Example 1 was only that in this example, a median particle diameter D50 of the petroleum coke secondary particles was 2 μm. Other conditions and parameters were exactly the same as those in Example 1.

### Example 6

The difference between this example and Example 1 was only that in this example, a median particle diameter D50 of the petroleum coke secondary particles was 10 μm. Other conditions and parameters were exactly the same as those in Example 1.

### Comparative Example 1

The difference between this comparative example and Example 1 was only that in this comparative example, both the first active material layer and the second active material layer use the needle coke primary particles as negative electrode materials. Other conditions and parameters were exactly the same as those in Example 1.

### Comparative Example 2

The difference between this comparative example and Example 1 was only that in this comparative example, both the first active material layer and the second active material layer use the petroleum coke secondary particles as negative electrode materials. Other conditions and parameters were exactly the same as those in Example 1.

### Comparative Example 3

The difference between this comparative example and Example 1 was only that in this comparative example, the first active material layer uses the petroleum coke secondary particles as active materials, and the second active material layer uses the needle coke primary particles as negative electrode materials. Other conditions and parameters were exactly the same as those in Example 1.

### Performance Test:

The negative electrode sheets prepared in the examples and comparative examples were used to prepare batteries, which were subjected to a 4C fast-charge cycling test, and the capacity retention rates of the batteries were recorded. The test method was as follows:
1. the batteries were discharged under 25° C. at 0.33 C to 2.5 V, and then charged to 4.35 V at 0.33 C constant current, wherein the cut-off current was 0.02 C;
2. the first step was repeated for three times, wherein the capacity of the third time was recorded as Q;
3. the batteries were discharged to 2.5 V at 0.33 Q, charged to 5% Q at 0.33 Q, charged to 5% Q at 0.5 Q, charged to 5% Q at 1 Q, charged to 5% Q at 2 Q, charged to 10% Q at 4.5 Q, charged to 10% Q at 4.2 C, charged to 10% Q at 4.0 C, charged to 5% Q at 3.8 Q, charged to 5% Q at 3.6 Q, charged to 5% Q at 3.4 Q, charged to 5% Q at 3.2 Q, charged to 5% Q at 2.8 Q, charged to 5% Q at 2.5 Q, charged to 10% Q at 0.5 C, charged to 4.35V at 0.33 C; and
4. the third step was repeated for 3000 times, and the battery capacity retention rates were recorded.

Test results were shown in Table 1.

TABLE 1

| | 0.33 C energy | Number of | Capacity |
|---|---|---|---|
| | density/Wh/Kg | 4 C cycles | retention rate |
| Example 1 | 280 | 2500 | 87.7% |
| Example 2 | 285 | 2350 | 85.6% |
| Example 3 | 267 | 2520 | 87.9% |
| Example 4 | 288 | 2030 | 82.4% |
| Example 5 | 272 | 2540 | 88% |
| Example 6 | 292 | 2025 | 81.5% |
| Comparative | 248 | 1830 | 62.4% |
| Example 1 | | | |
| Comparative | 255 | 1920 | 65.6% |
| Example 2 | | | |
| Comparative | 266 | 1980 | 68.8% |
| Example 3 | | | |

From Table 1, it can be seen from Examples 1 to 2 that the 4C fast-charge cycling of the battery cores prepared from the negative electrode sheets according to the present disclosure can reach 2350 times or more, the capacity retention rate can reach 85.6% or more, and the 0.33 C energy density can reach 280 Wh/Kg or more. The increase in the thickness of the first active material layer can increase the energy density of the battery core, but it will affect the fast charging performance of the battery core.

From the comparison between Example 1 and Examples 3 to 4, it can be concluded that in the modified negative electrode sheet of the present disclosure, the particle diameter of the needle coke primary particles affects the performances thereof. If the median particle diameter D50 of the needle coke primary particles was controlled to be in a range from 8 μm to 20 μm, the performances of the modified negative electrode sheet were better. If the particle diameter of the needle coke primary particles was too large, the energy density of the battery core was increased, but the fast charging cycle performance of the battery core was reduced. If the particle diameter of the needle coke primary particles was too small, the fast charging performance of the battery core was improved, but the energy density of the battery core was reduced.

From the comparison between Example 1 and Examples 5 to 6, it can be concluded that in the modified negative electrode sheet of the present disclosure, the particle diameter of the petroleum coke secondary particles affects the performances thereof. If the median particle diameter D50 of the petroleum coke secondary particles was controlled to be in a range from 3 μm to 8 μm, the performances of the modified negative electrode sheet were better. If the particle diameter of the petroleum coke secondary particles was too large, the energy density of the battery core was increased, but the fast charging cycle performance of the battery core was reduced. If the particle diameter of the petroleum coke secondary particles was too small, the fast charging performance of the battery core was improved, but the energy density of the battery core was reduced.

From the comparison between Example 1 and Comparative Examples 1 to 3, it can be concluded that in the modified negative electrode sheet of the present disclosure, the active materials of a negative electrode slurry coated on an outer layer were petroleum coke secondary particles, and the OI value of the secondary particles was small, which was beneficial for the diffusion of lithium ions into an inner layer, thereby preventing lithium precipitation of the lithium ions in high-rate charging and discharging processes, and improving the fast charging performance and safety performance of the battery core. The active materials of a negative electrode slurry coated on an inner layer were needle coke primary particles, and the primary particles can increase the compacted density of a negative electrode at the inner layer, thereby increasing the energy density of the battery core. Furthermore, the coating manner of coating the inner layer with the primary particles makes an internal structure of an electrode sheet more stable, which can improve the cycle performance of the battery core.

What is claimed is:

1. A modified negative electrode sheet, comprising a current collector, and a first negative electrode active material layer and a second negative electrode active material layer that are sequentially stacked on a surface of the current collector, negative electrode active materials of the first negative electrode active material layer being needle coke primary particles, and negative electrode active materials of the second negative electrode active material layer being petroleum coke secondary particles.

2. The modified negative electrode sheet according to claim 1, wherein the petroleum coke secondary particles are prepared by the following method:
mixing petroleum coke particles, a resin, and a dispersant, and stirring to obtain a mixture, and heating the mixture to obtain the petroleum coke secondary particles.

3. The modified negative electrode sheet according to claim 2, wherein the resin comprises phenolic resin.

4. The modified negative electrode sheet according to claim 2, wherein the dispersant comprises anhydrous ethanol.

5. The modified negative electrode sheet according to claim 2, wherein a mass ratio of the petroleum coke particles to the resin is 100:(5 to 10).

6. The modified negative electrode sheet according to claim 2, wherein in the stirring and heating processes, the heating manner is performed as follows: heating the mixture from room temperature to a temperature of 300° C. in a time period from 0.5 hours to 2 hours, then heating the mixture from 300° C. to 500° C. in a time period from 0.5 hours to 1.5 hours, and finally heating the mixture from 500° C. to a temperature ranging from 600° C. to 700° C. in a time period from 1 hour to 3 hours, and maintaining the temperature for 3 hours to 5 hours.

7. The modified negative electrode sheet according to claim 1, wherein an OI value of the needle coke primary particles ranges from 8 to 12; and
preferably, an OI value of the petroleum coke secondary particles ranges from 4 to 7.

8. The modified negative electrode sheet according to claim 1, wherein a median particle diameter D50 of the needle coke primary particles ranges from 8 μm to 20 μm; and
preferably, a median particle diameter D50 of the petroleum coke secondary particles ranges from 3 μm to 8 μm.

9. The modified negative electrode sheet according to claim 1, wherein a thickness of the first negative electrode active material layer ranges from 110 μm to 120 μm; and
preferably, a thickness of the second negative electrode active material layer ranges from 75 μm to 80 μm.

10. The modified negative electrode sheet according to claim 1, wherein the first negative electrode active material layer and the second negative electrode active material layer further comprise a conductive agent and a binder;
preferably, the conductive agent comprises any one of or a combination of at least two of conductive carbon black, a carbon nanotube, and acetylene black; and
preferably, the binder comprises polyvinylidene fluoride.

11. The modified negative electrode sheet according to claim 1, wherein a mass ratio of the needle coke primary particles to the conductive agent to the binder in the first negative electrode active material layer is (96-97):(0.5-1):(2-3); and
preferably, a mass ratio of the petroleum coke secondary particles to the conductive agent to the binder in the second negative electrode active material layer is (95-97):(1-1.5):(2.5-3).

12. The modified negative electrode sheet according to claim 3, wherein the dispersant comprises anhydrous ethanol.

13. The modified negative electrode sheet according to claim 3, wherein a mass ratio of the petroleum coke particles to the resin is 100:(5 to 10).

14. The modified negative electrode sheet according to claim 3, wherein in the stirring and heating processes, the heating manner is performed as follows: heating the mixture from room temperature to a temperature of 300° C. in a time period from 0.5 hours to 2 hours, then heating the mixture from 300° C. to 500° C. in a time period from 0.5 hours to 1.5 hours, and finally heating the mixture from 500° C. to a temperature ranging from 600° C. to 700° C. in a time period from 1 hour to 3 hours, and maintaining the temperature for 3 hours to 5 hours.

15. The modified negative electrode sheet according to claim 2, wherein an OI value of the needle coke primary particles ranges from 8 to 12; and
preferably, an OI value of the petroleum coke secondary particles ranges from 4 to 7.

16. The modified negative electrode sheet according to claim 2, wherein a median particle diameter D50 of the needle coke primary particles ranges from 8 μm to 20 μm; and
preferably, a median particle diameter D50 of the petroleum coke secondary particles ranges from 3 μm to 8 μm.

17. The modified negative electrode sheet according to claim 2, wherein a thickness of the first negative electrode active material layer ranges from 110 μm to 120 μm; and
preferably, a thickness of the second negative electrode active material layer ranges from 75 μm to 80 μm.

18. The modified negative electrode sheet according to claim 2, wherein the first negative electrode active material layer and the second negative electrode active material layer further comprise a conductive agent and a binder;
preferably, the conductive agent comprises any one of or a combination of at least two of conductive carbon black, a carbon nanotube, and acetylene black; and
preferably, the binder comprises polyvinylidene fluoride.

19. A method for preparing a modified negative electrode sheet, comprising the following steps:
(1) mixing the needle coke primary particles, the conductive agent, carboxymethyl cellulose (CMC), the binder, and a solvent to obtain a first negative electrode slurry; and mixing the petroleum coke secondary particles, the conductive agent, the CMC, the binder, and the solvent to obtain a second negative electrode slurry; and
(2) coating the first negative electrode slurry on one side or two sides of the current collector, drying, and then coating the second negative electrode slurry on a surface of the first negative electrode slurry, followed by drying and cold pressing to obtain the modified negative electrode sheet;
wherein the modified negative electrode sheet comprises a current collector, and a first negative electrode active material layer and a second negative electrode active material layer that are sequentially stacked on a surface of the current collector, negative electrode active materials of the first negative electrode active material layer are needle coke primary particles, and negative electrode active materials of the second negative electrode active material layer are petroleum coke secondary particles.

20. A lithium-ion battery, comprising a modified negative electrode sheet, wherein the modified negative electrode sheet comprises a current collector, and a first negative electrode active material layer and a second negative electrode active material layer that are sequentially stacked on a surface of the current collector, negative electrode active materials of the first negative electrode active material layer are needle coke primary particles, and negative electrode active materials of the second negative electrode active material layer are petroleum coke secondary particles.
